(19) United States
(12) Patent Application Publication
(10) Pub. No.: US 2021/0176349 A1
(43) Pub. Date: Jun. 10, 2021

(54) PACKET DATA CONVERGENCE PROTOCOL (PDCP) DUPLICATION ENHANCEMENTS

(71) Applicant: QUALCOMM Incorporated, San Diego, CA (US)

(72) Inventors: Jelena DAMNJANOVIC, Del Mar, CA (US); Tao LUO, San Diego, CA (US); Ozcan OZTURK, San Diego, CA (US); Linhai HE, San Diego, CA (US)

(21) Appl. No.: 17/111,270

(22) Filed: Dec. 3, 2020

Related U.S. Application Data
(60) Provisional application No. 62/945,194, filed on Dec. 8, 2019.

(51) Int. Cl. H04L 29/14; H04W 72/04; H04W 72/08

(52) U.S. Cl. CPC H04L 69/40; H04W 72/085; H04W 72/044

(57) ABSTRACT

Aspects of the present disclosure relate to wireless communications, and more particularly to techniques for enhancing packet data convergence protocol (PDCP) duplication, for example, by allowing a user equipment (UE) to autonomously activate/deactivate (uplink (UL)) PDCP duplication. A method that may be performed by a UE includes detecting one or more events related to channel conditions and activating PDCP duplication at the UE in response to the detection. In some cases, the UE may provide a network entity an indication of the PDCP duplication activation/deactivation. In response to the indication, the network entity may, for example, activate/deactivate downlink (DL) PDCP duplication.

### CROSS-REFERENCE TO RELATED APPLICATION(S)

This application claims benefit of and priority to U.S. Provisional Application No. 62/945,194, filed Dec. 8, 2019, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate generally to wireless communications systems, and more particularly, to packet duplication.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New Radio (NR) (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation (CA).

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide techniques for packet data convergence protocol (PDCP) duplication.

Certain aspects of the subject matter described in this disclosure can be implemented in a method for wireless communication by a user equipment (UE). The method generally includes detecting one or more events related to channel conditions. The method generally includes activating PDCP duplication at the UE in response to the detection.

Certain aspects of the subject matter described in this disclosure can be implemented in a method for wireless communication by a network entity. The method generally includes receiving an indication, from a UE, that the UE has activated or deactivated uplink (UL) packet data convergence protocol (PDCP) duplication at the UE in response to a detection of one or more events related to channel conditions at the UE. The method generally includes taking one or more actions based on the indication.

Certain aspects of the subject matter described in this disclosure can be implemented in an apparatus for wireless communication by a UE. The apparatus generally includes a memory and at least one processor coupled to the memory, the at least one processor being configured to detect one or more events related to channel conditions and activate PDCP duplication at the UE in response to the detection.

Certain aspects of the subject matter described in this disclosure can be implemented in an apparatus for wireless communication by a network entity. The apparatus generally includes a memory and at least one processor coupled to the memory, the at least one processor being configured to receive an indication, from a UE, that the UE has activated or deactivated UL PDCP duplication at the UE in response to a detection of one or more events related to channel conditions at the UE and take one or more actions based on the indication.

Certain aspects of the subject matter described in this disclosure can be implemented in an apparatus for wireless communication by a UE. The apparatus generally includes means for detecting one or more events related to channel conditions, and means for activating PDCP duplication at the UE in response to the detection.

Certain aspects of the subject matter described in this disclosure can be implemented in an apparatus for wireless communication by a network entity. The apparatus generally includes means for receiving an indication, from a UE, that the UE has activated or deactivated UL PDCP duplication at the UE in response to a detection of one or more events related to channel conditions at the UE and means for taking one or more actions based on the indication.

Certain aspects of the subject matter described in this disclosure can be implemented in a computer-readable medium having instructions stored thereon to cause a user equipment (UE) to detect one or more events related to channel conditions and activate PDCP duplication at the UE in response to the detection.

Certain aspects of the subject matter described in this disclosure can be implemented in a computer-readable medium having instructions stored thereon to cause a network entity to receive an indication, from a UE, that the UE has activated or deactivated UL PDCP duplication at the UE in response to a detection of one or more events related to channel conditions at the UE and take one or more actions based on the indication.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is an example frame format for certain wireless communication systems (e.g., new radio (NR)), in accordance with certain aspects of the present disclosure.

FIG. 6 is a diagram showing examples for implementing a communication protocol stack, in accordance with certain aspects of the present disclosure.

FIG. 7 is a block diagram of a protocol stack illustrating a configuration for carrier aggregation (CA), in accordance with certain aspects of the present disclosure.

FIG. 8 is a flow diagram illustrating example operations for wireless communication by a UE, in accordance with certain aspects of the present disclosure.

FIG. 9 is a flow diagram illustrating example operations for wireless communication by a network entity, in accordance with certain aspects of the present disclosure.

FIG. 10 is a call flow diagram illustrating example signaling for packet data convergence protocol (PDCP) activation and deactivation, in accordance with aspects of the present disclosure.

FIG. 11 illustrates a communications device that may include various components configured to perform operations for the techniques disclosed herein in accordance with aspects of the present disclosure.

FIG. 12 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for new radio (NR) (NR access technology or 5G technology).

NR may support various wireless communication services, such as enhanced mobile broadband (eMBB) targeting wide bandwidth (e.g. 80 MHz beyond), millimeter wave (mmW) targeting high carrier frequency (e.g. 27 GHz or beyond), massive machine type communications (mMTC) targeting non-backward compatible MTC techniques, and/or mission critical targeting ultra-reliable low-latency communications (URLLC). These services may include latency and reliability requirements. These services may also have different transmission time intervals (TTIs) to meet respective quality of service (QoS) requirements. In addition, these services may co-exist in the same subframe.

In certain systems, (e.g., 3rd Generation Partnership Project (3GPP) Release-13 long term evolution (LTE) networks), enhanced machine type communications (eMTC) are supported, targeting low cost devices, often at the cost of lower throughput. eMTC may involve half-duplex (HD) operation in which uplink transmissions and downlink transmissions can both be performed—but not simultaneously. Some eMTC devices (e.g., eMTC user equipments (UEs)) may look at (e.g., be configured with or monitor) no more than around 1 MHz or six resource blocks (RBs) of bandwidth at any given time. eMTC UEs may be configured to receive no more than around 1000 bits per subframe. For example, these eMTC UEs may support a max throughput of around 300 Kbits per second. This throughput may be sufficient for certain eMTC use cases, such as certain activity tracking, smart meter tracking, and/or updates, etc., which may consist of infrequent transmissions of small amounts of data; however, greater throughput for eMTC devices may be desirable for other cases, such as certain Internet-of-Things (IoT) use cases, wearables such as smart watches, etc.

The following description provides examples of packet data convergence protocol (PDCP) duplication, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

### Example Wireless Communications System

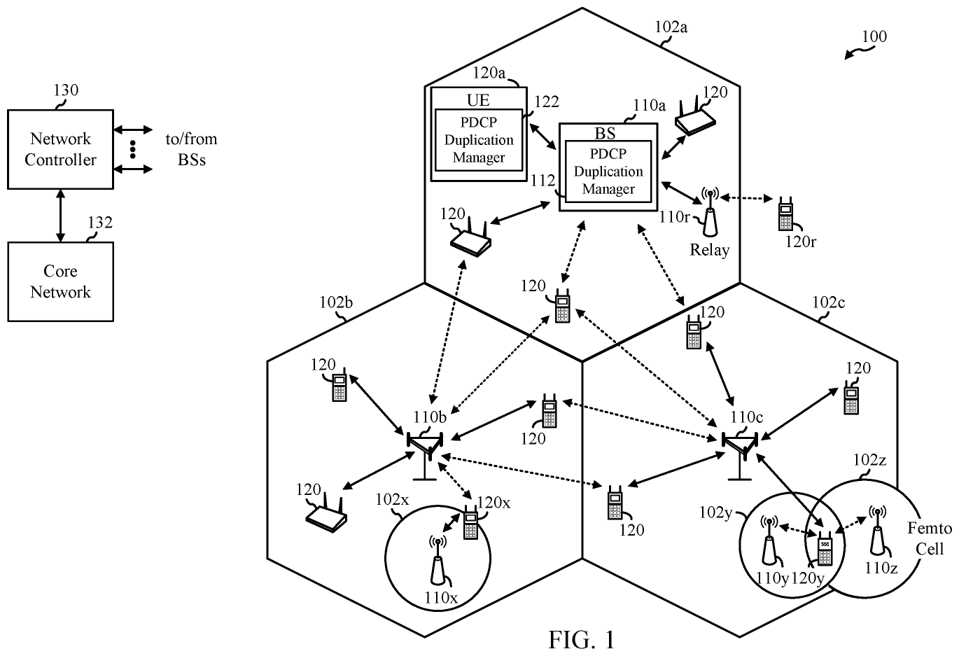

FIG. 1 illustrates an example wireless communication network 100 in which aspects of the present disclosure may be performed. For example, the wireless communication network 100 may be a new radio (NR) system (e.g., a 5G NR network). As shown in FIG. 1, the wireless communication network 100 may be in communication with a core network 132. The core network 132 may be in communication with one or more base stations (BSs) 110a-z (each also individually referred to herein as BS 110 or collectively as BSs 110) and/or user equipment (UE) 120-a-y (each also individually referred to herein as UE 120 or collectively as UEs 120) in the wireless communication network 100 via one or more interfaces.

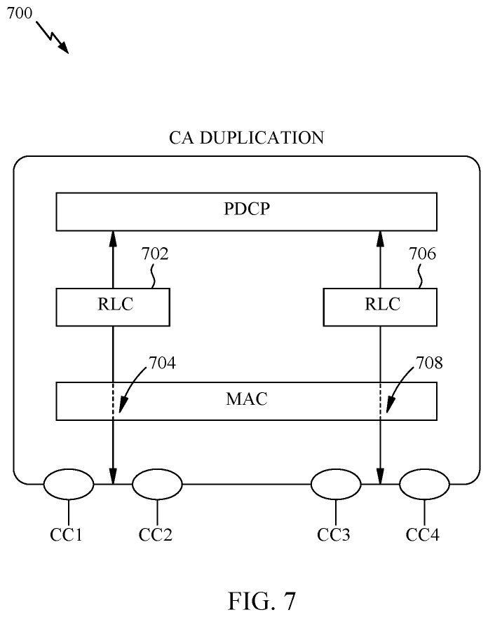

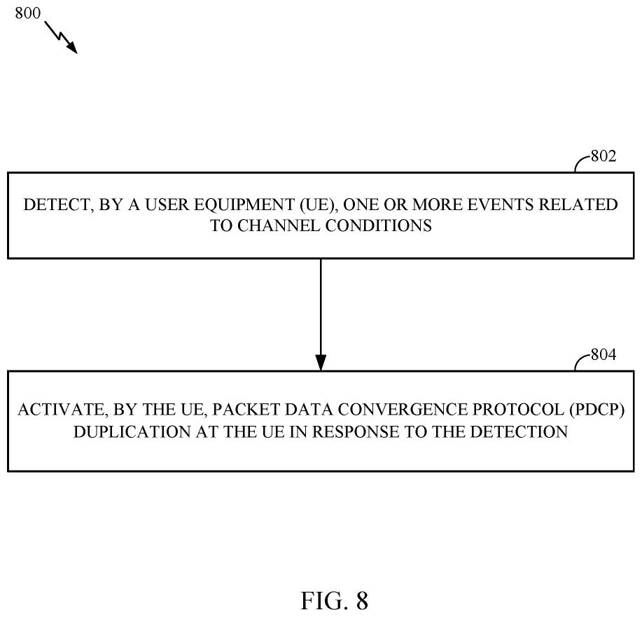

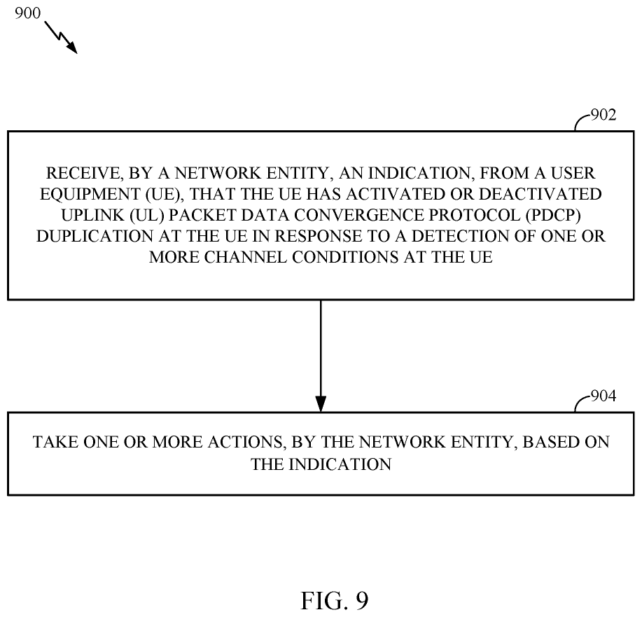

As shown in FIG. 1, the wireless communication network 100 may include one or more UEs 120 configured to perform operations 800 of FIG. 8 (e.g., to autonomously activate PDCP duplication). UE 120a may include a PDCP duplication manager 122 that detects one or more events related to channel conditions and activates PDCP duplication at the UE 120a in response to the detection, in accordance with certain aspects of the present disclosure. Similarly, the wireless communication network 100 may also include one or more BSs 110 (e.g., gNBs) configured to perform operations 900 of FIG. 9 (e.g., to process an indication received from a UE 120 performing operations 700 of FIG. 7). The BS 110a may include a PDCP duplication manager 112 that receives an indication, from a UE, that the UE has activated or deactivated uplink (UL) PDCP duplication at the UE in response to a detection of one or more events related to channel conditions at the UE and takes one or more actions based on the indication.

As illustrated in FIG. 1, the wireless communication network 100 may include a number of BSs 110 and other network entities. A BS may be a station that communicates with UEs. Each BS 110 may provide communication coverage for a particular geographic area. In 3^{rd} Generation Partnership Program (3GPP), the term “cell” can refer to a coverage area of a Node B and/or a NB subsystem serving this coverage area, depending on the context in which the term is used. In NR systems, the term “cell” and eNB, Node B, 5G NB, next generation NB (gNB), access point (AP), BS, NR BS, or transmission reception point (TRP) may be interchangeable. In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, a tone, a subband, a subcarrier, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BS for the femto cells 102y and 102z, respectively. A BS may support one or multiple (e.g., three) cells.

The wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

The wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, a macro BS may have a high transmit power level (e.g., 20 Watts) whereas a pico BS, a femto BS, and a relay may have a lower transmit power level (e.g., 1 Watt).

The wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may be coupled to a set of BSs and provide coordination and control for these BSs. The network controller 130 may communicate with the BSs 110 via a backhaul. The BSs 110 may also communicate with one another, for example, directly or indirectly via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices or narrowband IoT (NB-IoT) devices.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

Certain wireless networks (e.g., LTE) utilize orthogonal frequency division multiplexing (OFDM) on the DL and single-carrier frequency division multiplexing (SC-FDM) on the UL. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block (RB)”) may be 12 subcarriers (or 180 kHz). Consequently, the nominal fast Fourier transform (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.8 MHz (i.e., 6 RBs), and there may be 1, 2, 4, 8 or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR.

As noted above, a radio access network (RAN) may include a CU and a DU. A NR BS (e.g., gNB, 5G Node B, Node B, TRP, AP) may correspond to one or multiple BSs. NR cells can be configured as access cell (ACells) or data only cells (DCells). For example, the RAN (e.g., a central unit or distributed unit) can configure the cells. DCells may be cells used for CA or dual connectivity (DC), but not used for initial access, cell selection/reselection, or handover. In some cases DCells may not transmit synchronization signals—in some case cases DCells may transmit synchronization signaling (SS). NR BSs may transmit DL signals to UEs indicating the cell type. Based on the cell type indication, the UE may communicate with the NR BS. For example, the UE may determine NR BSs to consider for cell selection, access, handover, and/or measurement based on the indicated cell type.

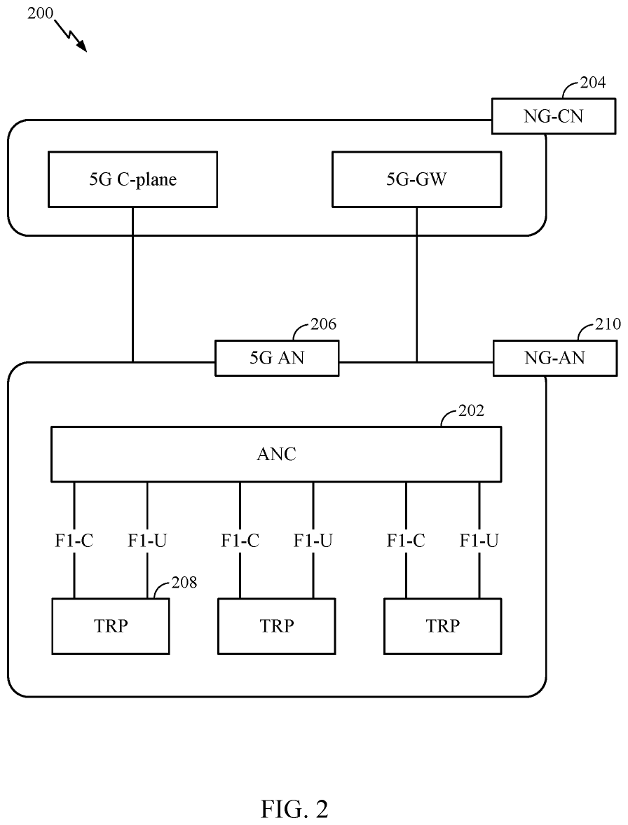

FIG. 2 illustrates an example logical architecture of a distributed radio access network (RAN) 200, which may be implemented in the wireless communication network 100 illustrated in FIG. 1. A 5G access node (AN) 206 may include an access node controller (ANC) 202. The ANC 202 may be a CU of the distributed RAN 200. The backhaul interface to the next generation core network (NG-CN) 204 may terminate at the ANC 202. The backhaul interface to neighboring next generation access nodes (NG-ANs) 210 may terminate at the ANC 202. The ANC 202 may include one or more TRPs 208 (which may also be referred to as BSs, NR BSs, Node Bs, 5G NBs, Aps, gNBs, or some other term). As described above, a TRP may be used interchangeably with “cell”.

The TRPs 208 may be a DU. The TRPs may be connected to one ANC (ANC 202) or more than one ANC (not illustrated). For example, for RAN sharing, radio as a service (RaaS), and service specific ANC deployments, the TRP 208 may be connected to more than one ANC. A TRP may include one or more antenna ports. The TRPs may be configured to individually (e.g., dynamic selection) or jointly (e.g., joint transmission) serve traffic to a UE.

The distributed RAN 200 may support fronthauling solutions across different deployment types. For example, the RAN 200 architecture may be based on transmit network capabilities (e.g., bandwidth, latency, and/or jitter). The distributed RAN 200 may share features and/or components with LTE. For example, the NG-AN 210 may support DC with NR and may share a common fronthaul for LTE and NR. The distributed RAN 200 may enable cooperation between and among TRPs 208. For example, cooperation may be preset within a TRP and/or across TRPs via the ANC 202. According to aspects, no inter-TRP interface may be needed/present.

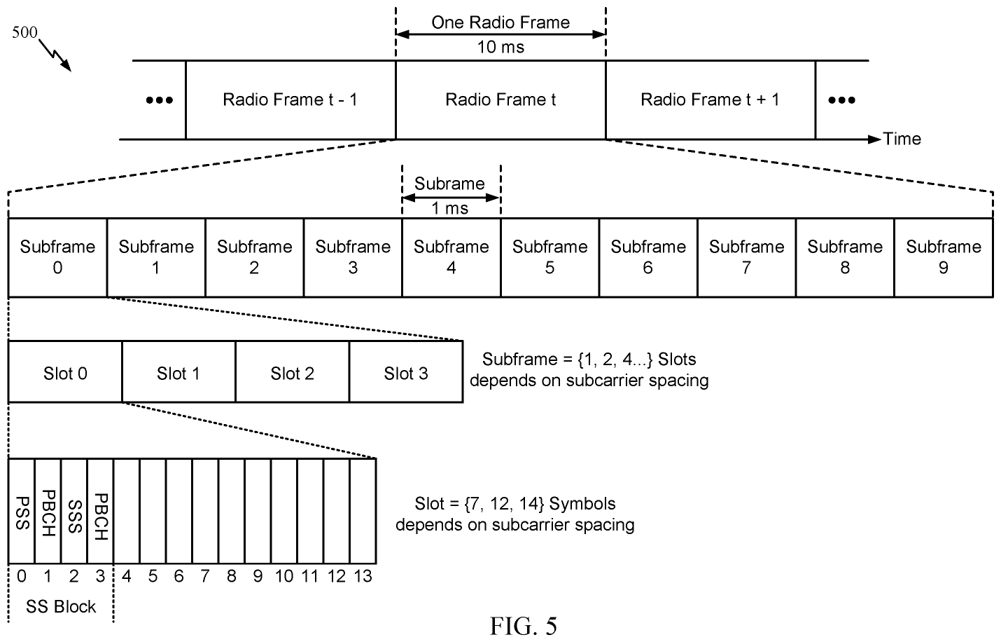

According to certain aspects, a dynamic configuration of split logical functions may be present within the distributed RAN 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layer may be adaptably placed at the DU or CU (e.g., TRP or ANC, respectively). According to certain aspects, a BS may include a CU (e.g., ANC 202) and/or one or more DUs (e.g., one or more TRPs 208).

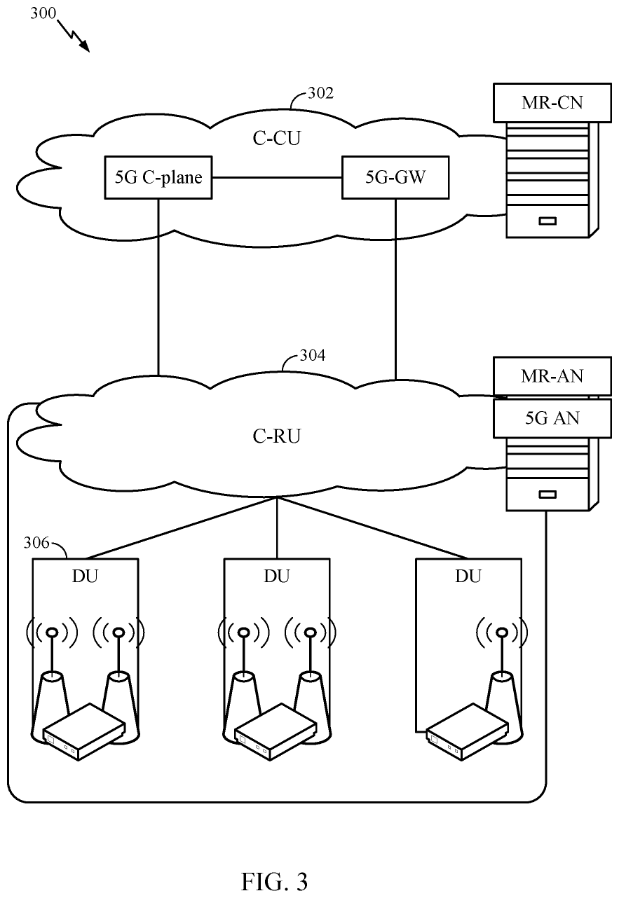

FIG. 3 illustrates an example physical architecture of a distributed RAN 300, according to aspects of the present disclosure. A centralized core network unit (C-CU) 302 may host core network functions. The C-CU 302 may be centrally deployed. C-CU functionality may be offloaded (e.g., to advanced wireless services (AWS)), in an effort to handle peak capacity.

A centralized RAN unit (C-RU) 304 may host one or more ANC functions. The C-RU 304 may host core network functions locally. The C-RU 304 may have distributed deployment. The C-RU 304 may be closer to the network edge.

A DU 306 may host one or more TRPs (e.g., an edge node (EN), an edge unit (EU), a radio head (RH), a smart radio head (SRH), or the like). The DU may be located at edges of the network with radio frequency (RF) functionality.

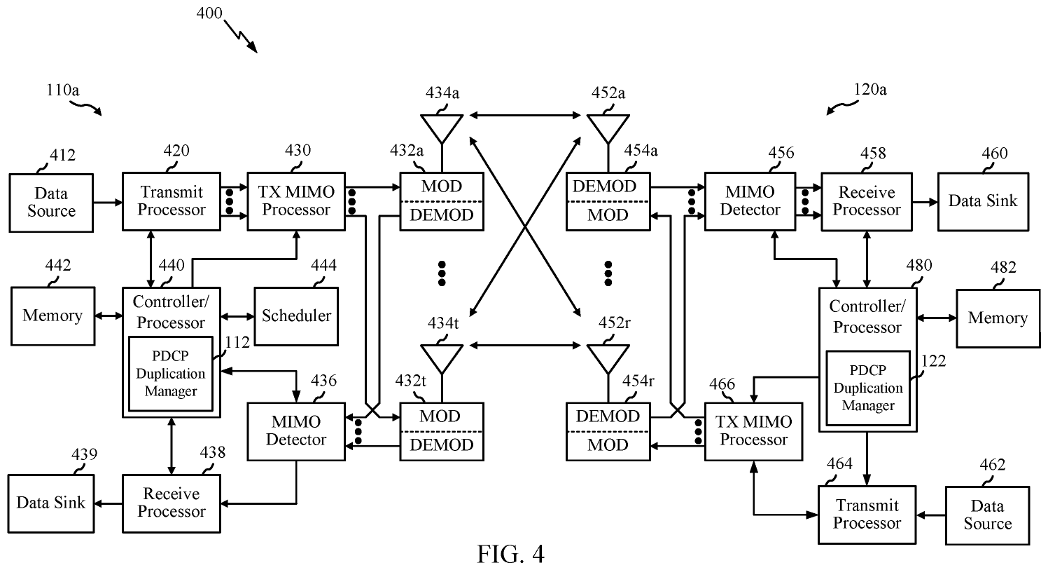

FIG. 4 illustrates example components of the BS 110 and UE 120 (as depicted in the wireless communication network 100 of FIG. 1), which may be used to implement aspects of the present disclosure.

At the BS 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), group common PDCCH (GC PDCCH) etc. The data may be for the Physical Downlink Shared Channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 420 may process (e.g., encode and symbol map) the data and control information to obtain data symbols and control symbols, respectively. The transmit processor 420 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator in transceivers 432a-432t may process a respective output symbol stream (e.g., for OFDM, etc.) to obtain an output sample stream. Each modulator may further process (e.g., convert to analog, amplify, filter, and upconvert) the output sample stream to obtain a DL signal. DL signals from modulators in transceivers 432a-432t may be transmitted via the antennas 434a-434t, respectively.

At the UE 120, the antennas 452a-452r may receive the DL signals from the BS 110 and may provide received signals to the demodulators (DEMODs) in transceivers 454a-454r, respectively. Each demodulator in transceivers 454a-454r may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators in transceivers 454a-454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the UL, at the UE 120, a transmit processor 464 may receive and process data (e.g., for the PUSCH) from a data source 462 and control information (e.g., for the Physical Uplink Control Channel (PUCCH) from the controller/processor 480. The transmit processor 464 may also generate reference symbols for a reference signal (RS) (e.g., for a sounding reference signal (SRS)). The symbols from the transmit processor 464 may be precoded by a TX MIMO processor 466 if applicable, further processed by the demodulators 454a-454r (e.g., for SC-FDM, etc.), and transmitted to the BS 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The memories 442 and 482 may store data and program codes for the BS 110 and the UE 120, respectively. A scheduler 444 may schedule UEs for data transmission on the downlink and/or uplink.

Antennas 452, processors 466, 458, 464, and/or controller/processor 480 of the UE 120a and/or antennas 434, processors 440, 430, and 438, and/or controller/processor 440 of the BS 110a may be used to perform the various techniques and methods described herein. For example, as shown in FIG. 4, the controller/processor 480 of the UE 120a has a PDCP duplication manager 122 that detects one or more events related to channel conditions and activates PDCP duplication at the UE 120a in response to the detection, according to aspects described herein. As shown in FIG. 4, the controller/processor 440 of the BS 110a has a PDCP duplication manager 112 that receives an indication, from a UE, that the UE has activated or deactivated UL PDCP duplication at the UE in response to a detection and takes one or more actions based on the indication, according to aspects described herein. Although shown at the controller/processor, other components of the UE 120a and the BS 110a may be used to perform the operations herein.

NR may utilize orthogonal frequency division multiplexing (OFDM) with a cyclic prefix (CP) on the UL and DL. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

FIG. 5 is a diagram showing an example of a frame format 500 for NR. The transmission timeline for each of the DL and UL may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the subcarrier spacing (SCS). Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 5. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a PDSC) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

Beamforming may be supported and beam direction may be dynamically configured. Multiple-input multiple-output (MIMO) transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based. NR networks may include entities such as central units (CUs) and distributed units (DUs).

In LTE, the basic transmission time interval (TTI) or packet duration is the 1 subframe. In NR, a subframe is still 1 ms, but the basic TTI is referred to as a slot. A subframe contains a variable number of slots (e.g., 1, 2, 4, 8, 16, . . . slots) depending on the tone-spacing (e.g., 15, 30, 60, 120, 240 . . . kHz).

In some examples, access to the air interface may be scheduled, wherein a scheduling entity (e.g., a BS) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. BSs are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

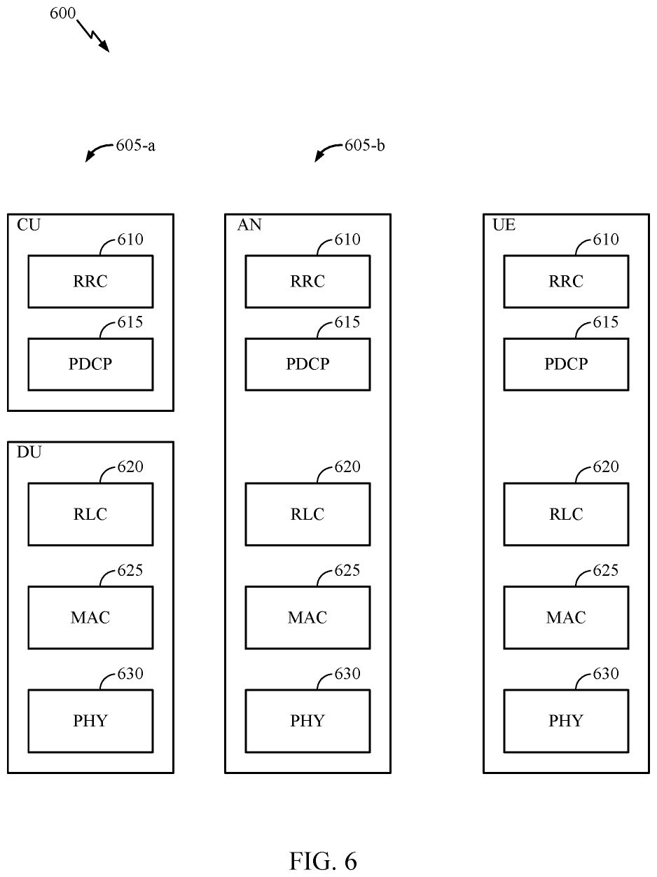

FIG. 6 illustrates a diagram 600 showing examples for implementing a communications protocol stack, according to aspects of the present disclosure. The illustrated communications protocol stack may be implemented by devices operating in a in a 5G system (e.g., a system that supports UL-based mobility). Diagram 600 illustrates a communications protocol stack including a Radio Resource Control (RRC) layer 610, a Packet Data Convergence Protocol (PDCP) layer 615, a Radio Link Control (RLC) layer 620, a Medium Access Control (MAC) layer 625, and a Physical (PHY) layer 630. In various examples, the layers of a protocol stack may be implemented as separate modules of software, portions of a processor or application-specific integrated circuit (ASIC), portions of non-collocated devices connected by a communications link, or various combinations thereof. Collocated and non-collocated implementations may be used, for example, in a protocol stack for a network access device (e.g., ANs, CUs, and/or DUs) or a UE.

A first option 605-a shows a split implementation of a protocol stack, in which implementation of the protocol stack is split between a centralized network access device (e.g., an ANC 202 in FIG. 2) and distributed network access device (e.g., DU 208 in FIG. 2). In the first option 605-a, an RRC layer 610 and a PDCP layer 615 may be implemented by the CU, and an RLC layer 620, a MAC layer 625, and a PHY layer 630 may be implemented by the DU. In various examples, the CU and the DU may be collocated or non-collocated. The first option 605-a may be useful in a macro cell, micro cell, or pico cell deployment.

A second option 505-b illustrates a unified implementation of a protocol stack, in which the protocol stack is implemented in a single network access device (e.g., an AN, a NR BS, a NR NB, a network node (NN), or the like). In the second option, the RRC layer 610, the PDCP layer 615, the RLC layer 620, the MAC layer 625, and the PHY layer 530 may each be implemented by the AN. The second option 605-b may be useful in a femto cell deployment.

Regardless of whether a network access device implements part or all of a protocol stack, a UE may implement an entire protocol stack (e.g., the RRC layer 610, the PDCP layer 615, the RLC layer 620, the MAC layer 625, and the PHY layer 630).

### Example Techniques for Enhancing Packet Data Convergence Protocol (PDCP) Duplication

Solutions proposed to meet the demanding performance requirements of services supported by NR, such as enhanced mobile broadband (eMBB) and ultra-reliable low-latency communication (URLLC), may include, for example, packet duplication at the packet data convergence protocol (PDCP) layer. Specifically, PDCP duplication may provide further enhancements in terms of reliability for low latency services and signaling radio bearers (SRBs), albeit with a negative impact on resource efficiency (due to the duplication of resources needed for transmittal of the same PDCP packet multiple times).

To provide an improved latency-efficiency tradeoff, aspects of the present disclosure provide possible enhancements for PDCP duplication, for example, by allowing a user equipment (UE) to autonomously activate and deactivate PDCP duplication.

In some cases, a UE may monitor channel conditions using existing mechanisms, such as a beam failure instance (BFI) indications, or dedicated mechanisms used to help detect deteriorating channel conditions before a beam failure occurs. Once conditions are met, triggering the UE to activate PDCP duplication, the UE may check, prior to activation, the amount of available resources to ensure that PDCP duplication is likely to result in increased reliability (a desired effect when activating PDCP duplication). For example, the UE may check whether diverse carriers are available. Diverse carriers may be carriers with different operating frequency ranges such as frequency range 1 (FR1) which includes sub-6 GHz frequency bands and frequency range 2 (FR2) which includes frequency bands from 24.25 GHz to 52.6 GHz.

In some cases, however, PDCP duplication may not be sensible. For example, if a physical obstruction (e.g., any blocking object, such as a car, a building, etc.) is encountered, additional directional transmissions, even on diverse frequencies, are likely to fail.

As noted above, PDCP duplication involves sending the same PDCP packet data unit (PDU) twice (or more). Accordingly, the original PDCP PDU may be sent on the original radio link control (RLC) entity and the corresponding duplicate may be sent on the additional RLC entity. For example, PDCP duplication may include multi-connectivity (MC) or carrier-aggregation (CA) type communication.

FIG. 7 is a block diagram illustrating a configuration for PDCP duplication using carrier aggregation (CA) with two RLC entities, in accordance with certain aspects of the present disclosure. As shown in FIG. 7, a first RLC entity 702 associated with two component carriers (CC1 and CC2) may be used for one of the duplicated PDCP PDUs, while a second RLC entity 706 associated with two other component carriers (CC3 and CC4) may be used for another one of the duplicated PDCP PDUs. When PDCP duplication is configured for a radio bearer (i.e., configured by radio resource control (RRC) signaling per radio bearer), a secondary RLC entity and a secondary logical channel (LC) may be added to the radio bearer to handle duplicated PDUs (RLC entity 706 and corresponding logical channel 708, as shown in FIG. 7).

The two different logical channels may either belong to the same medium access control (MAC) entity (i.e., in CA) or to different MAC entities (i.e., in dual connectivity (DC)). To achieve diversity, an original PDCP PDU and the corresponding duplicated PDCP PDU are typically not transmitted on the same carrier. A separate logical channel ID (LCID) may be used for a MAC CE controlling PDCP duplication. Accordingly, activation and deactivation of PDCP may be managed by the MAC layer. For each LC, RRC may control logical channel prioritization (LCP) mapping restrictions. A parameter, referred to as lcp-allowedServingCells, may configure the allowed cells for uplink (UL) and/or downlink (DL) transmission.

Aspects of the present disclosure provide apparatus, methods, processing systems, and computer readable mediums generally directed to techniques for enhancing PDCP duplication.

FIG. 8 is a flow diagram illustrating example operations 800 for wireless communication, in accordance with certain aspects of the present disclosure. The operations 800 may be performed, for example, by a UE (such as UE 120 in the wireless communication network 100) to autonomously activate and/or deactivate (UL) PDCP duplication. The operations 800 may be complementary operations by the UE to the operations 900 performed by the network entity (e.g., such as BS 110 in the wireless communication network 100). Operations 800 may be implemented as software components that are executed and run on one or more processors (e.g., processor 480 of FIG. 4). Further, the transmission and reception of signals by the UE in operations 800 may be enabled, for example, by one or more antennas (e.g., antennas 452 of FIG. 4). In certain aspects, the transmission and/or reception of signals by the UE may be implemented via a bus interface of one or more processors (e.g., processor 480) obtaining and/or outputting signals.

The operations 800 may begin, at block 802, by the UE detecting one or more events related to channel conditions. At block 804, the UE activates PDCP duplication at the UE in response to the detection.

FIG. 9 is a flow diagram illustrating example operations 900 for wireless communication, in accordance with certain aspects of the present disclosure. The operations 900 may be performed, for example, by a network entity (e.g., such as BS 110 in the wireless communication network 100) to receive an indication from a UE that the UE has activated or deactivated UL PDCP duplication. The operations 900 may be complementary operations by the network entity to the operations 800 performed by the UE (e.g., such as UE 120 in the wireless communication network 100). Operations 900 may be implemented as software components that are executed and run on one or more processors (e.g., processor 440 of FIG. 4). Further, the transmission and reception of signals by the network entity in operations 900 may be enabled, for example, by one or more antennas (e.g., antennas 434 of FIG. 4). In certain aspects, the transmission and/or reception of signals by the network entity may be implemented via a bus interface of one or more processors (e.g., processor 440) obtaining and/or outputting signals.

The operations 900 begin, at block 902, by the network entity receiving an indication, from a UE, that the UE has activated or deactivated UL PDCP duplication at the UE in response to a detection. At block 904, the network entity takes one or more actions based on the indication.

Autonomous PDCP duplication activation/deactivation, as described herein, may allow a UE to react quickly based on channel conditions which may result in improved efficiency. For example, the UE may decide not to activate PDCP duplication to avoid duplicating resources when not necessary and/or when reliability gains are not likely to result. In other words, PDCP duplication may be autonomously activated only when needed and autonomously deactivated when not necessary. Autonomous activation/deactivation at the UE allows the UE to react swiftly without waiting for configuration/reconfiguration (e.g., activation/deactivation of PDCP duplication) from the network entity.

There are various conditions that may trigger a UE to activate or deactivate PDCP duplication.

In some cases, a UE may utilize existing mechanisms, such as existing beam failure detection (e.g., triggers). BFD is typically configured per cell and uses a counter for beam failure instances (BFI COUNTER). The BFI COUNTER for BFI indication is initially set to 0.

In some cases, to achieve quick activation, as soon as the BFI COUNTER of a cell is incremented to 1, the UE may activate PDCP duplication. In other cases, a configurable threshold may be used (e.g., and the UE may activate PDCP duplication when the counter reaches the configured threshold). The UE may deactivate PDCP duplication upon expiration of the beamFailureDetectionTimer. In some cases, the UE may use a separate timer (e.g., a newly defined timer, preconfigured/configured by RRC) which is started and re-started each time a BFI is received.

PDCP activation may be performed for the LCIDs for which the cell is allowed to use for transmission, as configured by the RRC.

In some cases, a new MAC CE may be defined (for the UE) to indicate to the network (i.e., indicate to the network entity) that PDCP duplication has been activated/deactivated. Accordingly, the network entity may take one or more actions based on the indication. For example, the network entity may activate/deactivate DL PDCP duplication based on the indication that the UE has activated/deactivated UL PDCP duplication.

In some cases, rather than re-using the BFD mechanism, a deteriorating channel condition indication, configured by RRC, may be used. Accordingly, when using such a mechanism, PDCP activation may be based on both a lower layer indication and a new threshold used to indicate deteriorating channel conditions. The deteriorating channel condition may be a condition that is different than a beam failure event (for example, a drop in signal-to-noise ratio (SNR), a temporary obstruction, etc.). In some examples, the deteriorating channel condition may be a condition that occurs ahead of BFD (e.g., before a BFI indication). When indication of this deteriorating channel condition is received, the UE may activate PDCP duplication.

In such cases, the deactivation may be based on a new timer (which may preconfigured/configured by RRC). The timer may be started/restarted when the (new channel problem instance) indication is received from the lower layer. When the timer expires, PDCP duplication may be deactivated.

A UE may select cells for transmission of the PDCP duplicated packets in an effort to ensure that the duplicated packets are routed on diverse type of carriers. For example, the UE may attempt to duplicate PDCP packets on FR1 and FR2 type carriers or FR2 carriers in different bands. In contrast, duplication over two FR2 carriers in the same band may not be very useful; therefore, the UE may avoid this selection.

The UE may also apply various other criterion before activating PDCP duplication. For example, the UE may activate PDCP duplication upon receiving indication from the lower layers and the availability of diverse cells. The UE may choose among RRC preconfigured cells for duplication or among all RRC configured cells (or some other subset).

In some cases, the UE may use PDCP duplication activation mechanisms as a method of path selection for UE power saving. In such cases, PDCP duplication may be activated, but only one cell may be chosen (i.e., chosen based on the channel quality) to be used for transmission of a packet. In other words, while there may effectively be no duplication in this case, activating PDCP duplication allows for suitable cell selection for a packet transmission among the configured/allowed cells.

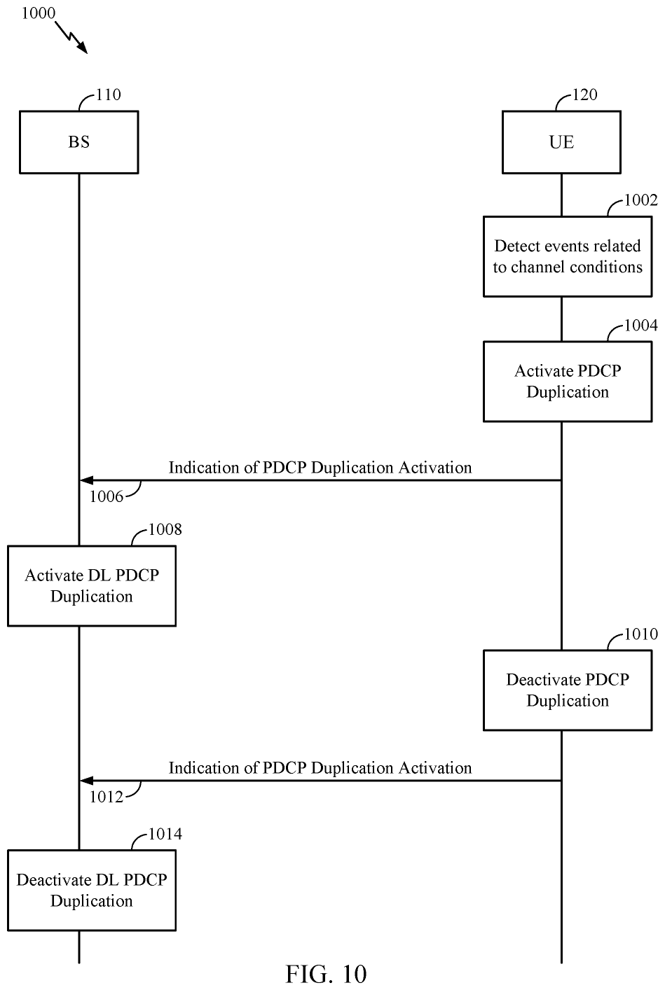

FIG. 10 is a call flow diagram illustrating example signaling 1000 for PDCP activation and deactivation, in accordance with aspects of the present disclosure. As shown in FIG. 10, at 1002, UE 120 may detect events related to channel conditions. As mentioned above, in some examples, UE 120 may detect a beam failure event. In some examples, UE 120 may detect a deteriorating channel condition (ahead of BFD). Accordingly, at 1004, UE 120 may activate UL PDCP duplication in response to the detection. In some examples, the UE may start a timer upon detection of events related to channel conditions.

At 1006, UE 120 may provide an indication of the activation of PDCP duplication to a network entity (e.g., such as BS 110 in the wireless communication network 100). In some cases, the indication may be provided via a MAC-CE. In response, at 1008, BS 110 may activate DL PDCP duplication based on the indication that the UE has activated UL PDCP duplication.

At 1010, UE 120 may deactivate PDCP duplication. As mentioned above, in some examples, deactivating PDCP may be based upon expiration of a timer. In some examples, deactivating PDCP may be based upon a timer that is started or restarted with each BFI when the detected event involves a beam failure.

At 1012, UE 120 may provide an indication of the deactivation of PDCP triggering BS 110 to deactivate DL PDCP duplication, at 1014.

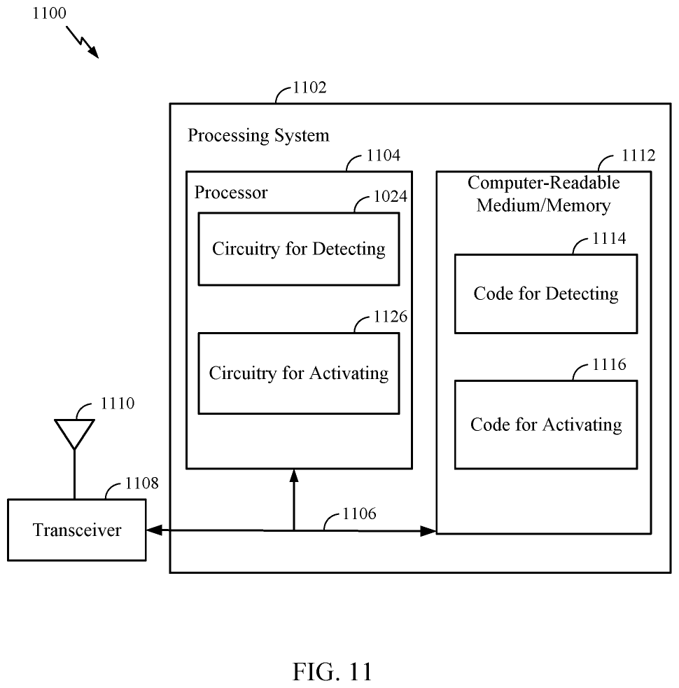

FIG. 11 illustrates a communications device 1100 that may include various components (e.g., corresponding to means-plus-function components) configured to perform operations for the techniques disclosed herein, such as the operations illustrated in FIG. 8. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 8, or other operations for performing the various techniques discussed herein for PDCP duplication activation/deactivation. In certain aspects, computer-readable medium/memory 1112 stores code 1114 for detecting (e.g., for detecting one or more events related to channel conditions) and code 1116 for activating (e.g., activating PDCP duplication at the UE in response to the detection). In certain aspects, the processor 1104 has circuitry configured to implement the code stored in the computer-readable medium/memory 1112. The processor 1104 includes circuitry 1124 for detecting (e.g., for detecting one or more events related to channel conditions) and circuitry 1126 for activating (e.g., activating PDCP duplication at the UE in response to the detection).

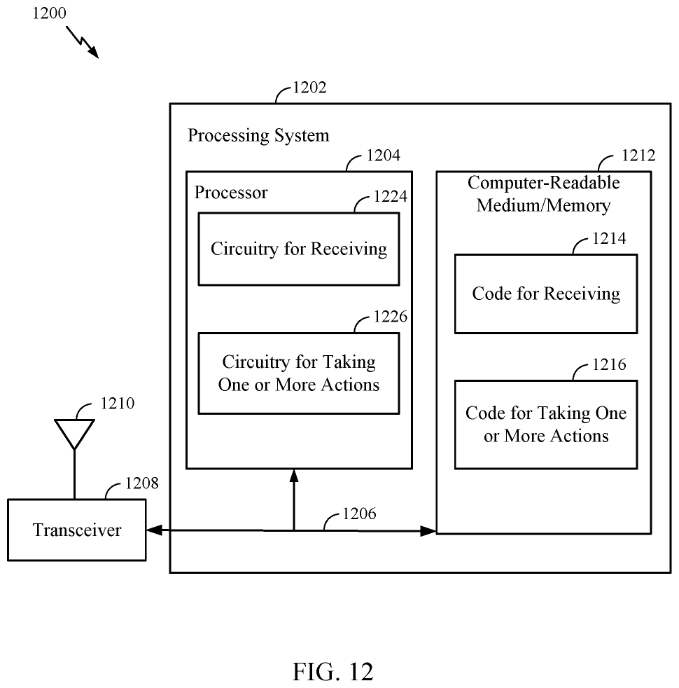

FIG. 12 illustrates a communications device 1200 that may include various components (e.g., corresponding to means-plus-function components) configured to perform operations for the techniques disclosed herein, such as the operations illustrated in FIG. 9. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 9, or other operations for performing the various techniques discussed herein for PDCP duplication activation/deactivation. In certain aspects, computer-readable medium/memory 1212 stores code 1214 for receiving (e.g., for receiving an indication, from a UE, that the UE has activated or deactivated UL PDCP duplication at the UE in response to a detection of one or more events related to channel conditions at the UE) and code 1216 for taking one or more actions (e.g., for taking one or more actions based on the indication). In certain aspects, the processor 1204 has circuitry configured to implement the code stored in the computer-readable medium/memory 1212. The processor 1204 includes circuitry 1224 for receiving (e.g., for receiving an indication, from a UE, that the UE has activated or deactivated UL PDCP duplication at the UE in response to a detection of one or more events related to channel conditions at the UE) and code 1216 for taking one or more actions (e.g., for taking one or more actions based on the indication).

### Example Aspects

Aspect 1: A method for wireless communication by a user equipment (UE), comprising detecting one or more events related to channel conditions and activating packet data convergence protocol (PDCP) duplication at the UE in response to the detection.

Aspect 2: The method of Aspect 1, wherein the one or more events involve a beam failure event.

Aspect 3: The method of Aspect 2, wherein the UE is configured to activate PDCP duplication if a beam failure instance (BFI) counter reaches a threshold value.

Aspect 4: The method of Aspect 3, wherein the threshold value is configurable.

Aspect 5: The method of any of Aspects 2-4, further comprising deactivating PDCP duplication based upon at least one of: expiration of a beam failure detection timer or a timer that is started or restarted with each BFI.

Aspect 6: The method of any of Aspects 1-5, wherein the activating is performed for one or more logical channel IDs (LCIDs) for which a cell is allowed to be used for transmission by the UE, based on network configuration.

Aspect 7: The method of any of Aspect 1-6, further comprising providing an indication of the activation of PDCP duplication or deactivation of PDCP duplication to a network entity.

Aspect 8: The method of Aspect 7, wherein the indication is provided via a media access control (MAC) control element (CE).

Aspect 9: The method of Aspect 7 or 8, wherein the indication is used by the network entity to activate or deactivate downlink (DL) PDCP duplication.

Aspect 10: The method of any of Aspects 1-9, wherein the one or more events involve detection of a deteriorating channel condition.

Aspect 11: The method of Aspect 10, wherein the deteriorating channel condition comprises a condition that is different than a beam failure event.

Aspect 12: The method of Aspect 10 or 11, further comprising starting or restarting a timer when the condition is detected and deactivating PDCP duplication if the timer expires.

Aspect 13: The method of any of Aspects 1-12, further comprising selecting cells for transmission such that the PDCP duplicated packets are routed on diverse type of carriers.

Aspect 14: The method of Aspect 13, wherein the cells are selected such that the PDCP duplicated packets are routed on different operating frequency bands.

Aspect 15: The method of any of Aspects 1-14, further comprising determining if diverse cells are available for transmitting the PDCP duplicated packets and activating the PDCP duplication only if diverse cells are available for transmitting the PDCP duplicated packets.

Aspect 16: The method of Aspect 15, wherein the determination is based on at least one of network preconfigured cells for PDCP duplication or a larger set of available network configured cells.

Aspect 17: The method of any of Aspects 1-16, wherein PDCP duplication is activated, but only one cell is chosen to be used for transmission of a PDCP packet.

Aspect 18: The method of Aspect 17, wherein activating PDCP duplication allows for suitable cell selection for a packet transmission (TX) among configured or allowed cells.

Aspect 19: A method for wireless communication by a network entity, comprising receiving an indication, from a user equipment (UE), that the UE has activated or deactivated uplink (UL) packet data convergence protocol (PDCP) duplication at the UE in response to a detection of one or more events related to channel conditions at the UE and taking one or more actions based on the indication.

Aspect 20: The method of Aspect 19, wherein the indication is received via a media access control (MAC) control element (MAC-CE).

Aspect 21: The method of Aspect 19 or 20, wherein the one or more events involve at least one of: a beam failure event or detection of a deteriorating channel condition.

Aspect 22: The method of any of Aspects 19-21, wherein the one or more actions comprise activating or deactivating downlink PDCP duplication.

Aspect 23: An apparatus for wireless communication by a user equipment (UE), comprising a memory and at least one processor coupled to the memory, the at least one processor being configured to detect one or more events related to channel conditions; and activate packet data convergence protocol (PDCP) duplication at the UE in response to the detection.

Aspect 24: The apparatus of Aspect 23, wherein the one or more events involve a beam failure event.

Aspect 25: The apparatus of Aspect 24, wherein the at least one processor is further configured to activate PDCP duplication if a beam failure instance (BFI) counter reaches a threshold value.

Aspect 26: The apparatus of Aspect 24 or 25, wherein the at least one processor is further configured to deactivate PDCP duplication based upon at least one of: expiration of a beam failure detection timer; or a timer that is started or restarted with each BFI.

Aspect 27: The apparatus of any of Aspects 23-26, wherein the one or more events involve detection of a deteriorating channel condition.

Aspect 28: The apparatus of Aspect 27, wherein the deteriorating channel condition comprises a condition that is different than a beam failure event.

Aspect 29: The apparatus of any of Aspects 23-28, wherein the at least one processor is further configured to: start or restart a timer when the condition is detected; and deactivate PDCP duplication if the timer expires.

Aspect 30: An apparatus for wireless communication by a network entity, comprising a memory and at least one processor coupled to the memory, the at least one processor being configured to receive an indication, from a user equipment (UE), that the UE has activated or deactivated uplink (UL) packet data convergence protocol (PDCP) duplication at the UE in response to a detection and take one or more actions based on the indication.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a user equipment (UE), comprising:
detecting one or more events related to channel conditions; and
activating packet data convergence protocol (PDCP) duplication at the UE in response to the detection.

2. The method of claim 1, wherein the one or more events involve a beam failure event.

3. The method of claim 2, wherein the UE is configured to activate PDCP duplication if a beam failure instance (BFI) counter reaches a threshold value.

4. The method of claim 3, wherein the threshold value is configurable.

5. The method of claim 2, further comprising deactivating PDCP duplication based upon at least one of:
expiration of a beam failure detection timer; or
a timer that is started or restarted with each BFI.

6. The method of claim 1, wherein the activating is performed for one or more logical channel IDs (LCIDs) for which a cell is allowed to be used for transmission by the UE, based on network configuration.

7. The method of claim 1, further comprising providing an indication of the activation of PDCP duplication or deactivation of PDCP duplication to a network entity.

8. The method of claim 7, wherein the indication is provided via a media access control (MAC) control element (CE).

9. The method of claim 7, wherein the indication is used by the network entity to activate or deactivate downlink (DL) PDCP duplication.

10. The method of claim 1, wherein the one or more events involve detection of a deteriorating channel condition.

11. The method of claim 10, wherein the deteriorating channel condition comprises a condition that is different than a beam failure event.

12. The method of claim 10, further comprising:
starting or restarting a timer when the condition is detected; and
deactivating PDCP duplication if the timer expires.

13. The method of claim 1, further comprising:
selecting cells for transmission such that the PDCP duplicated packets are routed on diverse type of carriers.

14. The method of claim 13, wherein the cells are selected such that the PDCP duplicated packets are routed on different operating frequency bands.

15. The method of claim 1, further comprising:
determining if diverse cells are available for transmitting the PDCP duplicated packets; and
activating the PDCP duplication only if diverse cells are available for transmitting the PDCP duplicated packets.

16. The method of claim 15, wherein the determination is based on at least one of:
network preconfigured cells for PDCP duplication; or
a larger set of available network configured cells.

17. The method of claim 1, wherein PDCP duplication is activated, but only one cell is chosen to be used for transmission of a PDCP packet.

18. The method of claim 17, wherein activating PDCP duplication allows for suitable cell selection for a packet transmission (TX) among configured or allowed cells.

19. A method for wireless communication by a network entity, comprising:
receiving an indication, from a user equipment (UE), that the UE has activated or deactivated uplink (UL) packet data convergence protocol (PDCP) duplication at the UE in response to a detection of one or more events related to channel conditions at the UE; and
taking one or more actions based on the indication.

20. The method of claim 19, wherein the indication is received via a media access control (MAC) control element (MAC-CE).

21. The method of claim 19, wherein the one or more events involve at least one of:
a beam failure event; or
detection of a deteriorating channel condition.

22. The method of claim 19, wherein the one or more actions comprise activating or deactivating downlink PDCP duplication.

23. An apparatus for wireless communication by a user equipment (UE), comprising:
a memory; and
at least one processor coupled to the memory, the at least one processor being configured to:
detect one or more events related to channel conditions; and
activate packet data convergence protocol (PDCP) duplication at the UE in response to the detection.

24. The apparatus of claim 23, wherein the one or more events involve a beam failure event.

25. The apparatus of claim 24, wherein the at least one processor is further configured to activate PDCP duplication if a beam failure instance (BFI) counter reaches a threshold value.

26. The apparatus of claim 24, wherein the at least one processor is further configured to deactivate PDCP duplication based upon at least one of:
expiration of a beam failure detection timer; or
a timer that is started or restarted with each BFI.

27. The apparatus of claim 23, wherein the one or more events involve detection of a deteriorating channel condition.

28. The apparatus of claim 27, wherein the deteriorating channel condition comprises a condition that is different than a beam failure event.

29. The apparatus of claim 23, wherein the at least one processor is further configured to:
start or restart a timer when the condition is detected; and
deactivate PDCP duplication if the timer expires.

30. An apparatus for wireless communication by a network entity, comprising:
a memory; and
at least one processor coupled to the memory, the at least one processor being configured to:
receive an indication, from a user equipment (UE), that the UE has activated or deactivated uplink (UL) packet data convergence protocol (PDCP) duplication at the UE in response to a detection; and
take one or more actions based on the indication.
